(19) United States
(12) Patent Application Publication
(10) Pub. No.: US 2021/0342250 A1
(43) Pub. Date: Nov. 4, 2021

(54) METHOD AND APARATUS FOR VERIFYING A SOFTWARE SYSTEM

(71) Applicant: SIEMENS INDUSTRY SOFTWARE NV, Leuven (BE)

(72) Inventors: Daniel Ratiu, München (DE); Sundaresan Sorakayalpet Arumugam, Chennai, Tamil Nadu (IN)

(21) Appl. No.: 17/280,910

(22) PCT Filed: Dec. 21, 2018
(86) PCT No.: PCT/EP2018/086646

§ 371 Date: Mar. 28, 2021

(30) Foreign Application Priority Data
Sep. 28, 2018 (IN) 201831036644

(51) Int. Cl. G06F 11/36

(52) U.S. Cl. CPC G06F 11/3608; G06F 11/3664; G06F 11/3684

(57) ABSTRACT

A method and apparatus for verifying a software system are provided. A data processing apparatus includes a processing unit and a memory unit communicatively coupled to the processing unit. The memory unit includes a simulation module and a verification module. The simulation module is configured to perform simulation of the software system for a first set of steps based on a first set of input values. The verification module is configured to instantaneously determine a state of the software system is which verification of the software system is to be initiated. The verification module is configured to initiate verification of the software system at the determined state, perform verification of the software system for a second set of steps based on a second set of input values, and output results of the verification of the software system on a display unit.

This application is the National Stage of International Application No. PCT/EP2018/086646, filed Dec. 21, 2018, which claims the benefit of Indian Patent Application No. IN 201831036644, filed Sep. 28, 2018. The entire contents of these documents are hereby incorporated herein by reference.

### BACKGROUND

The present disclosure relates generally to a field of design and development of software systems, and more particularly relates to a method and apparatus for verifying a software system.

Software systems such as reactive systems may process input data at each step using a software logic and produce an output command. An example of the reactive system is an adaptive cruise controller for a vehicle. The adaptive cruise controller takes input data such as distance to a next vehicle, current speed of vehicle, desired speed, and produces output command to a throttle.

After development of a software system, the software system is required to be verified to confirm compliance to a specification and expected behavior of the software system in real time. However, it is unpracticable to exhaustively test behavior of the software system, as this would require a large number of long traces of input data and a large amount of time. Currently, verification in a software system is performed using closed loop simulations. In this technique, a number of simulations are performed on the software system, which cover typical scenarios that the software system is likely to encounter in real time. However, verification of the software system using closed loop simulations would have very limited coverage due to a limited number of scenarios used, leading to significant number of false negatives.

### SUMMARY AND DESCRIPTION

A method and an apparatus for verifying a software system are disclosed. In one aspect, a data processing apparatus for verifying a software system includes a processing unit and a memory unit communicatively coupled to the processing unit. The memory unit includes a simulation module configured to perform simulation of a software system (e.g., a reactive system) for a first set of steps based on a first set of input values. For example, the simulation of the software system is performed using a closed loop simulation technique. The memory unit includes a verification module configured to determine a state of the software system in which verification of the software system is to be initiated, and initiate verification of the software system in the determined state. The verification module is configured to perform verification of the software system for a second set of steps based on a second set of input values, and a certain internal state of the software system, and output results of the verification of the software system on a display unit. For example, the verification of the software system is performed using a bounded-model checking technique. The verification module is also configured to generate a plurality of test vectors for testing the software system. The first set of steps are greater than the second set of steps, whereas the first set of input values are less than the second set of input values.

Additionally, the simulation module may be configured to determine a set of states associated with the software system during the first set of steps performed by the software system, and store values of state variables associated with each state of the software system in a verification database.

Further, the verification module is configured to instantaneously determine a state of the set of states in which the software system starts operating in an operation mode. Additionally, the verification module is configured to initialize the software system in the determined state using values of the state variables associated with the determined state, and initiate verification of the initialized software system in the determined state.

The verification module may also be configured to parse programming language statements associated with the software system, generate a control flow graph based on the parsed programming language statements, and determine whether any of the second set of input values are violated.

In another aspect, a method of verifying a software system includes performing simulation of a software system for a first set of steps based on a first set of input values, and determining a state of the software system in which verification of the software system is to be initiated. For example, the simulation of the software system may be performed using a closed loop simulation technique. The method may include initiating verification of the software system at the determined state, and performing verification of the software system for a second set of steps based on a second set of input values. For example, the verification of the software system may be performed using a bounded-model checking technique. The method also includes outputting results of the verification of the software system on a display unit. Also, the method may include generating a plurality of test vectors capable of testing the software system.

The method may also include determining a set of states associated with the software system during the first set of steps performed by the software system, and storing values of state variables associated with each state of the software system in a verification database.

The method may also include instantaneously determining a state from the set of states in which the software system starts operating in an operation mode. The method may include initializing the software system in the determined state using values of the state variables associated with the determined state, and initiating verification of the initialized software system in the determined state.

Also, the method may include parsing programming language statements associated with the software system, generating a control flow graph based on the parsed programming language statements, and determining whether any of the second set of input values are violated.

In yet another aspect, a non-transitory computer-readable storage medium, having machine-readable instructions stored therein, that when executed by a processing unit, cause the processing unit to perform a method described above, is provided.

### BRIEF DESCRIPTION OF THE DRAWINGS

FIG. 1 illustrates a block diagram of a data processing apparatus capable of performing verification of a software system, according to one embodiment;

FIG. 2 is a process flowchart illustrating an exemplary method of verifying the software system, according to one embodiment;

FIG. 3 is a process flowchart illustrating a detailed method of verifying the software system, according to one embodiment; and

FIG. 4 is a graphical representation depicting an approach applied in verification of the software system.

### DETAILED DESCRIPTION

Various embodiments are described with reference to the drawings, where like reference numerals are used to refer to like elements throughout. In the following description, numerous specific details are set forth in order to provide thorough understanding of embodiments of the present disclosure. It will be apparent to one skilled in the art, that these specific details need not be employed to practice embodiments of the present disclosure. In other instances, well known materials or methods have not been described in detail to avoid unnecessarily obscuring embodiments of the present disclosure. While the disclosure is susceptible to various modifications and alternative forms, specific embodiments thereof are shown by way of example in the drawings and will herein be described in detail. There is no intent, however, to limit the disclosure to the particular forms disclosed; the disclosure is to cover all modifications, equivalents, and alternatives falling within the spirit and scope of the present disclosure.

In one embodiment, a method and apparatus are provided to verify a software system in an appropriate state based on a plurality of input values. Typically, the software system includes software components that are responsible for performing one or more functions associated with hardware system. The hardware system may be a vehicle with an adaptive cruise controller. The software system takes inputs from various components of the vehicle such as speed, distance to vehicle in front, etc. and produces a command by processing the inputs. The command is processed by another component of the vehicle such as throttle to accelerate or decelerate the vehicle. Before the software system is deployed in an embedded system such as integrated circuit, it is important to verify behavior of the software system. Malfunctioning of the software system may lead to unexpected behavior of the adaptive cruise controller and sometimes may lead to vehicle crash. The following description describes a data processing system and a method performed by the data processing system to perform verification of the software system during design and development of the software system.

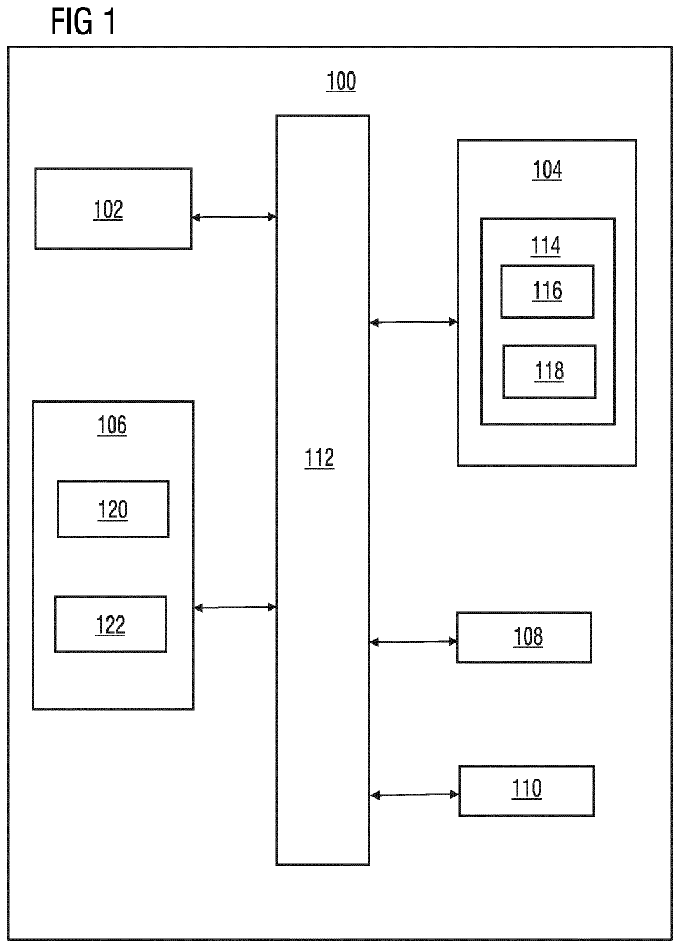

FIG. 1 illustrates a block diagram of a data processing apparatus 100 in which an embodiment may be implemented, for example, as a data processing apparatus particularly configured by software or otherwise to perform the processes as described herein. The data processing apparatus 100 may be a personal computer, a laptop computer, a tablet, smart phone, and the like. In FIG. 1, the data processing apparatus 100 includes a processing unit 102, an accessible memory 104, a storage unit 106, an input unit 108, a display unit 110, and a bus 112.

The processing unit 102, as used herein, provides any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 102 may also include embedded controllers, such as generic or programmable logic devices or arrays, application specific integrated circuits, single-chip computers, and the like.

The memory 104 may be volatile memory and non-volatile memory. The memory 104 may be coupled for communication with the processing unit 102. The processing unit 102 may execute instructions and/or code stored in the memory 104. A variety of computer-readable storage media may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 104 includes a software design and development (SDD) module 114.

The SDD module 114 includes a simulation module 116 and a verification module 118 stored in the form of machine-readable instructions on any of the above-mentioned storage media and may be in communication with and executed by the processing unit 102. When executed by the processing unit 102, the SDD module 114 causes the processing unit 102 to perform verification of a software system developed by the SDD module 114 and generate test vectors capable of testing the software system. The simulation module 116 causes the processing unit 102 to perform simulation of the software system for a first set of steps based on a first set of input values. The simulation of the software system enables determining a set of states associated with the software system when the first set of steps are performed by the software system using the first set of input values. The simulation of the software system is performed using a plant model from the plant model database 122. The plant model represents an environment associated with the software system.

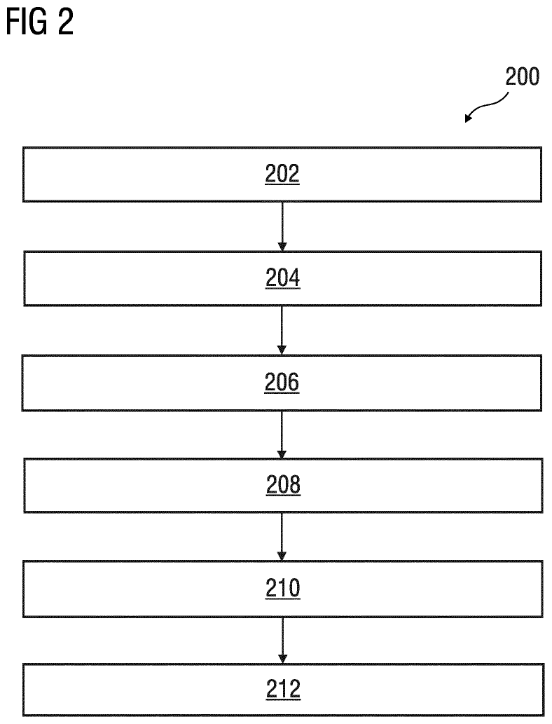

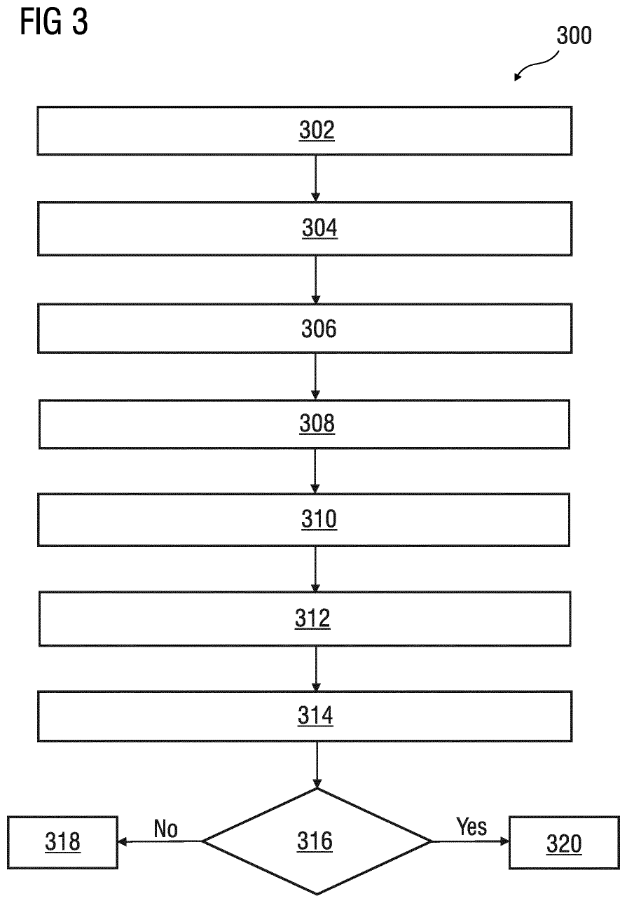

The verification module 118 causes the processing unit 102 to determine a state of the software system in which verification of the software system is to be initiated. The verification module 118 causes the processing unit 102 to initiate verification of the software system in the determined state and perform verification of the software system for second set of steps based on a second set of input values. The verification module 118 causes the processing unit 102 to output results of the verification of the software system on the display unit 110. Additionally, the verification module 118 causes the processing unit 102 to generate test vectors for testing the software system. Method steps or acts performed by the processing unit 102 to achieve the above functionality are described in greater detail in FIG. 2 and FIG. 3.

The storage unit 106 may be a non-transitory storage medium that stores a verification database 120 and a plant model database 122. The verification database 120 stores values of state variables associated with the set of states determined during simulation of the software system. In an adaptive cruise control (ACC) software system of a car, state variables may include mode of ACC (e.g. sport/economic, keep speed, keep distance, low speeds in traffic jams, etc.). In the “keep distance” mode, the ACC is to maintain a minimal distance from a vehicle in front. Additional state variables in this mode are “minimum distance to keep” (e.g., may have different values depending on road conditions, current vehicle speed, driving mode, inertia of the vehicle caused by vehicle and passengers weight, etc.), “health status of ACC” (e.g., may have values set by the self-diagnosis system which cross-checks the correct functioning of the ACC), and “history of distance to the next vehicle” (e.g., values are originating from the sensor after a braking was initiated and are used to adapt the breaking force to the current breaking conditions, such as road, variation of the speed of the vehicle in front, such that the breaking “feels smooth” to the driver but provides the required safety requirements).

The input unit 108 may include input devices such as a keypad, a touch-sensitive display, a camera (e.g., a camera receiving gesture-based inputs), etc. capable of receiving input signal such as user commands to design, develop, verify, and/or test a software system. The display unit 110 may be configured to display a graphical user interface that visualizes the software system along with results of the verification of the software system. The bus 112 acts as interconnect between the processing unit 102, the memory 104, the storage unit 106, the input unit 108, and the display unit 110.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter may also be used in addition or in place of the hardware depicted. The depicted example is provided for the purpose of explanation only and is not meant to imply architectural limitations with respect to the present disclosure.

A data processing apparatus in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event such as clicking a mouse button may be generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

Disclosed embodiments provide systems and methods that verify software system in an integrated-development environment. For example, disclosed techniques may perform simulation of a software system, determine a state associated with the software system in which verification is initiated, initiate the verification of the software system in the determined state, perform verification of the software system, and output results of the verification of the software system on a display unit.

Those skilled in the art will recognize that, for simplicity and clarity, the full structure and operation of all data processing apparatus suitable for use with the present disclosure is not being depicted or described herein. Instead, only so much of a data processing apparatus as is unique to the present disclosure or necessary for an understanding of the present disclosure is depicted and described. The remainder of the construction and operation of the data processing apparatus 100 may conform to any of the various current implementation and practices known in the art.

FIG. 2 is a process flowchart 200 illustrating an exemplary method of verifying a software system, according to one embodiment. In act 202, simulation of a software system is performed for a first set of steps based on a first set of input values. For example, the simulation of the software system is performed using closed-loop simulation technique. In the closed-loop simulation technique, the software system is simulated using a plant model that represent environment of the software system. The simulation of the software system is performed for the first set of steps during initialization mode of the software system. The simulation of the software system helps to bring the software system into a desired state that enables to perform verification of the software system. For example, the simulation of the software system is performed until a pre-defined condition is met. The condition may be (i) an adaptive cruise control (ACC) system of a car is started and initialized or (ii) the ACC system is in “keep distance mode” and has been running on icy roads for 10 minutes and another car in front started breaking violently. When the pre-defined condition is true, the inputs, generated by the plant model, that lead to a desired state of the software system are determined.

In act 204, a state of the software system in which verification of the software system is to be initiated is determined instantaneously. For example, the software system may operate in the initialization mode for some time and later switch to an operation mode (e.g., desired state). In some embodiments, a state in which the software system starts operating in the operation mode is determined. It is desired that the software system is verified in the desired state. Alternatively, it is desired that behavior of the software system is verified after the software system has reached the desired state. For example, correct behavior of adaptive cruise control of a car is to be verified upon detecting icy road conditions, high speed of the car, and the distance to the vehicle ahead of the car is decreasing rapidly (e.g., presumably due to a full-stop of the front car due to a collision with the vehicle in front of the front care).

In act 206, verification of the software system is initiated at the determined state of the software system. Also, simulation of the software system using a closed-technique is stopped at the determined state. During initiation of the verification, the software system is initialized in the determined state using values of state variables obtained during the simulation of the software system. At act 208, verification of the software system is performed for a second set of steps based on second set of input values. For example, the verification of the software system is performed using a bounded-model checking technique. The verification of the software system includes confirming whether the software system complies with a specification, confirming whether behavior of the software system during the operation mode meets expected behavior, and so on. This is achieved by determining whether the second set of input values are violated. In other words, output values corresponding to the second set of input values match expected output values. At act 210, results of verification of the software system are outputted on a display unit. For example, the results of verification may include one or more input values that are violated. At act 212, a plurality of test vectors capable of testing the software system in a desired operation mode is generated.

FIG. 3 is a process flowchart 300 illustrating a detailed method of verifying a software system, according to one embodiment. At act 302, a set of states associated with the software system are determined when the first set of steps is performed on the software system. At act 304, values of state variables associated with each state of the software system are stored in a verification database. At act 306, a state of the software system during which verification of the software system is to be initiated is determined. In some embodiments, a state of the set of states in which the software system starts operating in an operation mode is determined. The values of program variables are initialized symbolically to reflect desired starting point of the verification.

At act 308, the software system is initialized in the determined state using the stored values of the state variables associated with the determined state. At act 310, verification of the initialized software system is initiated in the determined state.

At act 312, programming language statements associated with the software system are parsed. At act 314, a control flow graph is generated based on the parsed programming language statements. At act 316, it is determined whether any of the second set of input values lead to the violation of the specification. If it is determined that the second set of input values lead to the violation of the specification, then at act 318, a notification indicating the verification of the software system failed along with input values that led to the violation of the specification are displayed on a display unit. If it is determined that the second set of input values do not lead to violation of the specification, then at act 320, a notification indicating the verification of the software system is successful is displayed on the display unit.

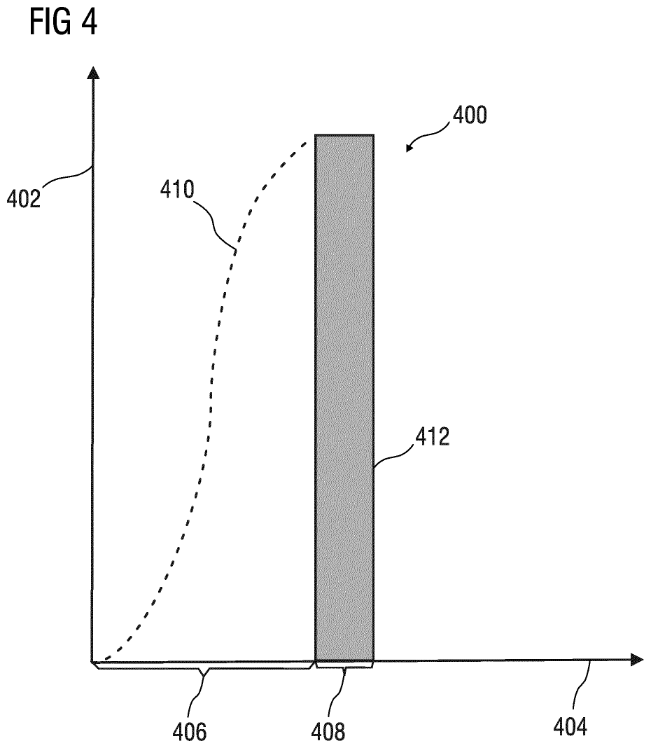

FIG. 4 is a graphical representation 400 depicting an approach applied in verification of a software system, according to one embodiment. As explained above, the verification of a software system with one input port is carried out using, for example, two approaches: a closed-loop simulation technique followed by a bounded-model checking technique. At first, simulation of the software system composed with a plant model is performed for N number of steps 406 based on an input value provided via the input port using a closed-loop simulation technique. The simulation of the software system enables a certain state in which verification of the software system may be initiated to be reached. During simulation of the software system, a set of states associated with the software system are determined, and values of state variables associated with the set of states are stored. Thereafter, a desired state for verifying the software system is determined. Accordingly, the software system is initialized using the values of state variables associated with the determined state. For example, a controller of a motor may need thousands of cycles to warm up the engine and reach an operation mode (e.g., desired state). However, verification of certain properties of the engine may need to be performed during the operation mode. The simulation of the software system helps to start verification in the desired state (e.g., the operation mode of the engine). In another example, after an adaptive cruise control (ACC) system is activated by a car driver, the ACC system needs hundreds of cycles to initialize a car monitoring state from which the ACC system may take control of a braking system of the car.

Then, verification of the software system is performed for M number of steps 408 based on a plurality of input values using a bounded-model checking technique. The bounded-model checking technique enables to exhaustively explore behavior of the software system for M number of steps 408. In one exemplary implementation, a C-level model checker processes programming language statements (e.g., C language statements) and transforms the programming language statements in a symbolic representation (e.g., a control flow graph). The C-level model checker determine one or more input values that lead to the violation (e.g., abnormal behavior of the software system). This is achieved by traversing through the control flow graph and identifying paths in the control flow graph that lead to violations. For example, the C-model checker uses a decision procedure to traverse through the control flow graph and identify paths that lead to violations. The decision procedure may employ a bit-vector logic including non-linear arithmetic and arrays to solve reachability of paths represented as a Boolean satisfiability problem.

The graphical representation 400 depicts the approach used in verification of the software system. The graphical representation 400 includes an X-axis 404 representing steps performed on the software system during verification of the software system, and a Y-axis 402 representing a number of inputs used for simulation and verification of the software system. As shown in the graphical representation 400, the simulation of the software system is performed for N number of steps 406 based on a single input value received at each of the N number of steps 406. Hence, the graphical representation 400 depicts a shape of input space covered by the simulation as a curved line 410. Following the simulation of the software system, the verification of the software system is performed for the M number of steps 408 in a desired state based on a plurality of input values received at each of the N number of steps 406. Hence, the shape of input space 412 covered by the bounded-model checking technique is a region.

The various embodiments, the methods, and apparatuses described in FIG. 1 to FIG. 4 verifies a software system using a combination of closed-loop simulation and a bounded-model checking. This is because, during initialization of the software system, simulation of the software system is performed over many steps but cover a small part of possible input space. In one embodiment, simulation of the software system quickly brings the software system to a desired state for verification of the software system. Also, increased coverage in terms of number of steps is achieved. At the desired state (e.g., mode of operation) of the software system, bounded-model checking is performed for a small number of steps but over a large input space. Thus, a possibility of detecting a higher number of faulty input values over a large input spaces is higher. Also, increased depth of verification is obtained.

The system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be an electronic, magnetic, optical, electromagnetic, infrared, or semiconductor system (or apparatus or device), or propagation mediums in and of themselves as signal carriers are not included in the definition of physical computer-readable medium that include a semiconductor or solid state memory, magnetic tape, a removable computer diskette, random access memory (RAM), a read only memory (ROM), a rigid magnetic disk, and an optical disk such as compact disk read-only memory (CD-ROM), compact disk read/write, and digital versatile disc (DVD). Both processors and program code for implementing each aspect of the technology may be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would present themselves to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A data processing apparatus for verifying a software system, the data processing apparatus comprising:
at least one processing unit; and
at least one memory unit communicatively coupled to the processing unit, wherein the at least one memory unit comprises:
a simulation module configured to perform simulation of the software system for a first set of steps based on a first set of input values; and
a verification module configured to:
determine a state of the software system in which verification of the software system is to be initiated;
initiate verification of the software system in the determined state;
perform verification of the software system for a second set of steps based on a second set of input values; and
output results of the verification of the software system on a display unit.

2. The data processing apparatus of claim 1, wherein the verification module is further configured to generate a plurality of test vectors for testing the software system.

3. The data processing apparatus of claim 1, wherein the simulation module is further configured to perform the simulation of the software system using a closed-loop simulation technique.

4. The data processing apparatus of claim 1, wherein the verification module is further configured to perform the verification of the software system using a bounded-model checking technique.

5. The data processing apparatus of claim 1, wherein the simulation module is further configured to:
determine a set of states associated with the software system during the first set of steps performed by the software system; and
store values of state variables associated with each state of the software system in a verification database.

6. The data processing apparatus of claim 1, wherein the verification module is further configured to:
instantaneously determine a state from the set of states in which the software system starts operating in an operation mode.

7. The data processing apparatus of claim 1, wherein the verification module is further configured to:
initialize the software system in the determined state using values of the state variables associated with the determined state; and
initiate verification of the initialized software system in the determined state.

8. The data processing apparatus of claim 1, wherein the verification module is further configured to:
parse programming language statements associated with the software system;
generate a control flow graph based on the parsed programming language statements; and
determine whether any of the second set of input values lead to violation of a specification of the software system.

9. A method of verifying a software system, the method comprising:
performing, by a data processing apparatus, simulation of a software system for a first set of steps based on a first set of input values;
determining, by the data processing apparatus, a state of the software system in which verification of the software system is to be initiated;
initiating, by the data processing apparatus, verification of the software system at the determined state;
performing, by the data processing apparatus, verification of the software system for a second set of steps based on a second set of input values; and
outputting, by the data processing apparatus, results of the verification of the software system on a display unit.

10. The method of claim 9, further comprising:
generating, by the data processing apparatus, a plurality of test vectors capable of testing the software system.

11. The method of claim 9, wherein the simulation of the software system is performed using a closed-loop simulation technique.

12. The method of claim 9, wherein the verification of the software system is performed using a bounded-model checking technique.

13. The method of claim 9, wherein performing the simulation of the software system comprises:
determining a set of states associated with the software system during the first set of steps performed by the software system; and
storing values of state variables associated with each state of the software system in a verification database.

14. The method of claim 9, wherein determining the state of the software system in which the verification of the software system is to be initiated comprises:
determining a state from the set of states in which the software system starts operating in an operation mode.

15. The method of claim 9, wherein initiating the verification of the software system at the determined state comprises:
initializing the software system in the determined state using values of the state variables associated with the determined state; and
initiating verification of the initialized software system in the determined state.

16. The method of claim 9, wherein performing the verification of the software system comprises:
parsing programming language statements associated with the software system;
generating a control flow graph based on the parsed programming language statements; and
determining whether any of the second set of input values lead to violation of a specification of the software system.

17. A non-transitory computer-readable storage that stores machine-readable instructions executable by a processing unit to verify a software system, the machine-readable instructions comprising:
performing simulation of a software system for a first set of steps based on a first set of input values;
determining a state of the software system in which verification of the software system is to be initiated;
initiating verification of the software system at the determined state;
performing verification of the software system for a second set of steps based on a second set of input values; and
outputting results of the verification of the software system on a display unit.

18. The non-transitory computer-readable storage medium of claim 17, wherein the machine-readable instructions further comprise:
generating a plurality of test vectors capable of testing the software system.

19. The non-transitory computer-readable storage medium of claim 17, wherein the machine-readable instructions further comprise:
parsing programming language statements associated with the software system;
generating a control flow graph based on the parsed programming language statements; and
determining whether any of the second set of input values lead to violation of a specification of the software system.

20. The non-transitory computer-readable storage medium of claim 17, wherein the simulation of the software system is performed using a closed-loop simulation technique, and
wherein the verification of the software system is performed using a bounded-model checking technique.
